(19) United States
(12) Patent Application Publication
(10) Pub. No.: US 2019/0320508 A1
(43) Pub. Date: Oct. 17, 2019

(54) MICROWAVE HEATING OF BORON STEEL BLANKS PRIOR TO THE HOT-STAMPING PROCESS

(71) Applicant: MATERIA GROUP LTD., Norwich (GB)

(72) Inventors: David M. Vickers, Norwich (GB); Manoj Gupta, Singapore (SG); Terry Cable, State College, PA (US)

(21) Appl. No.: 16/386,922

(22) Filed: Apr. 17, 2019

Related U.S. Application Data
(60) Provisional application No. 62/658,909, filed on Apr. 17, 2018.

(51) Int. Cl. H05B 6/80; C21D 9/46; C21D 1/18; C21D 6/00; H05B 6/78

(52) U.S. Cl. CPC H05B 6/80; C21D 9/46; B21D 37/16; C21D 6/00; H05B 6/78; C21D 1/18

(57) ABSTRACT

A method of heating a steel blank using a microwave heating furnace system for the hot stamping process includes providing a steel blank having a thickness ranging from 1 mm to 1.8 mm, pre-heating the streel blank to an initial temperature in a pre-heat chamber of the microwave heating furnace system, and directly heating the steel blank using microwave energy in a main heating zone of the microwave heating furnace system from the initial temperature to a temperature greater than 850° C. in less than 240 seconds.

### REFERENCE TO RELATED APPLICATIONS

This application claims priority from U.S. Ser. No. 62/658,909, filed Apr. 17, 2018, the entire content of which is incorporated herein by reference.

### FIELD OF THE INVENTION

The present invention relates to heating of boron steel blanks as part of the hot-stamping process and, in particular, to heating of steel blanks from Room Temperature (RT), which is taken to be between 20 to 25 degrees Celsius, with an average of 23° C., through a heating furnace.

### BACKGROUND OF THE INVENTION

In vehicle manufacturing, there has been a focus on the combination of decreasing weight and increasing strength in the key areas of a vehicle chassis.

Boron steel is used extensively in the automotive industry as side-door extrusion beams that provide passenger door support structures on a vehicle chassis. The demand for boron steel is due to the fact that this metal is both lightweight and strong—thus fulfilling the criteria in the automotive industry for the need to reduce weight and thus increase fuel economy.

Hot stamping is a process used to form ultra-high strength steel into complex shapes. It involves the heating of boron steel blanks from Room Temperature (RT) to approximately 1000° C., followed by formation and rapid cooling in specially designed dies. Hot stamped parts represent one of the most advanced light-weighting solutions for car body structure.

Hot stamping minimizes stress and spring-back in the material. The process also allows for increasing the level of hardness of the steel (MPa rating), which allows the forming of shapes that are simply not possible with other processes, as well as the provision of use of thinner steel. Hot-Stamping efficiently combines strength and complexity that can be formed in one relatively light-weight piece, so it requires lesser volume of raw materials and helps improve manufacturing efficiencies.

However, the current hot-stamping process has its disadvantages in that surface oxidation of the steel banks and deformation can occur due to the high temperature process, therefore it must allow for a separate descaling process on formed products.

Additionally, in terms of application of the hot stamping process, the heating furnaces that have mainly been used are either electric, gas or infra-red light to preheat a boron steel blank. After this process, the boron steel blank must be completely austenized by heating to a temperature of approximately 1000° C. and requires up to 20 minutes with electric radiation, gas furnace or infra-red light.

Heating furnaces that use electric or gas tend to be 20 m to 30 m in length, and as a result use a lot of unnecessary energy that increases the heating time and throughput rate—therefore these types of furnaces have no production flexibility.

In the case where high-frequency induction heating is applied to the hot-stamping process; although the heating furnaces can be shorter reducing the heating time, the downside is that this type of furnace has problems regarding precise temperature control. This is an important factor when heating such a thin steel which is subject to deformation as it passes through the furnace. In the case of these conventional technologies they are heating the “air” around the surface of the steel blank by energy transfer.

### SUMMARY OF THE INVENTION

The present invention provides a system for and method of heating thin metal blanks for a hot stamping process using a microwave heating furnace system.

The present invention provides a microwave heating furnace system for heating blanks for a hot-stamping process. The microwave heating furnace system includes an incoming feed for processing a steel blank into the furnace system, and a pre-heat chamber for heating the metal blank to an initial temperature. For example, the first temperature may be between 350° C. and 400° C.

The microwave heating furnace system further comprises a main heating zone connected to a pre-heat chamber. The main heating zone may include multiple heating sub-zones. The metal blank is pre-heated in the pre-heat chamber. The main heating zone is configured to heat the metal blank from the pre-heat chamber through a uniform increase in temperatures as the metal blank passes from one sub-zone to next sub-zone. Each of the heating sub-zones may be configured to have a gradual uniform increase in temperature.

The metal blanks may be boron steel blanks, magnesium boron steel, carbon steel or other thin metal sheets.

In the case of boron steel blanks, the steel blanks may have a thickness ranging from 1 mm to 1.8 mm.

The increase in temperature as the boron steel blank passes through the main heating zone can be between 800° C. and 1000° C. in a processing time of between 180 and 240seconds.

The microwave heating furnace system further comprises an outgoing section for transferring the steel blank to a subsequent hot stamping process.

The microwave heating furnace system further comprises a conveyor system for transferring the steel blank from the incoming feed through the pre-heating chamber and into the main heating zone to the outgoing section.

The method may include the step of pre-heating the steel blank to an initial temperature in the pre-heat chamber of the microwave heating furnace system, and directly heating the steel blank using microwave energy in the main heating zone of the microwave heating furnace system to a temperature greater than 800° C. in less than 240 seconds.

The pre-heat chamber may have a smaller footprint by having a height greater than its width. The conveyor system takes a U-shaped route running along the sides and bottom of the pre-heat chamber.

The pre-heating may be done using microwave energy, or combining with a form of thermal energy creating a hybrid system. In a microwave heating system, the steel blank is being directly heated using 100% microwave heating. In a hybrid system, the heating energy uses two types of energy, i.e., microwave and thermal energy for heating the steel blanks. In the present method, the thermal energy may come from the use of Silicon Carbide susceptors and insultation which are heated rapidly by microwaves, thus providing radiant uniform heat to the steel blanks.

The microwave heating furnace system may further comprise silicon carbide nanocoated clips or hooks used to hold the steel blank in place on the conveyor system.

The main heating zone and pre-heat chamber comprise steel doors to shield the microwave both into and out of the pre-heat chamber.

### BRIEF DESCRIPTION OF THE DRAWINGS

FIG. 1 is a schematic showing a cross-sectional view of a microwave furnace in accordance with an embodiment of the present invention;

FIG. 2 is a schematic cross-sectional view of the conveyor system in the microwave furnace in accordance with an embodiment of the present invention;

FIG. 3 is a schematic showing the hybrid heating including microwave heating and susceptor heating; and

FIG. 4 is a table showing the changes of the microhardness and strength of the samples under the microwave heating treatment in accordance with an embodiment of the present invention.

### DETAILED DESCRIPTION OF THE INVENTION

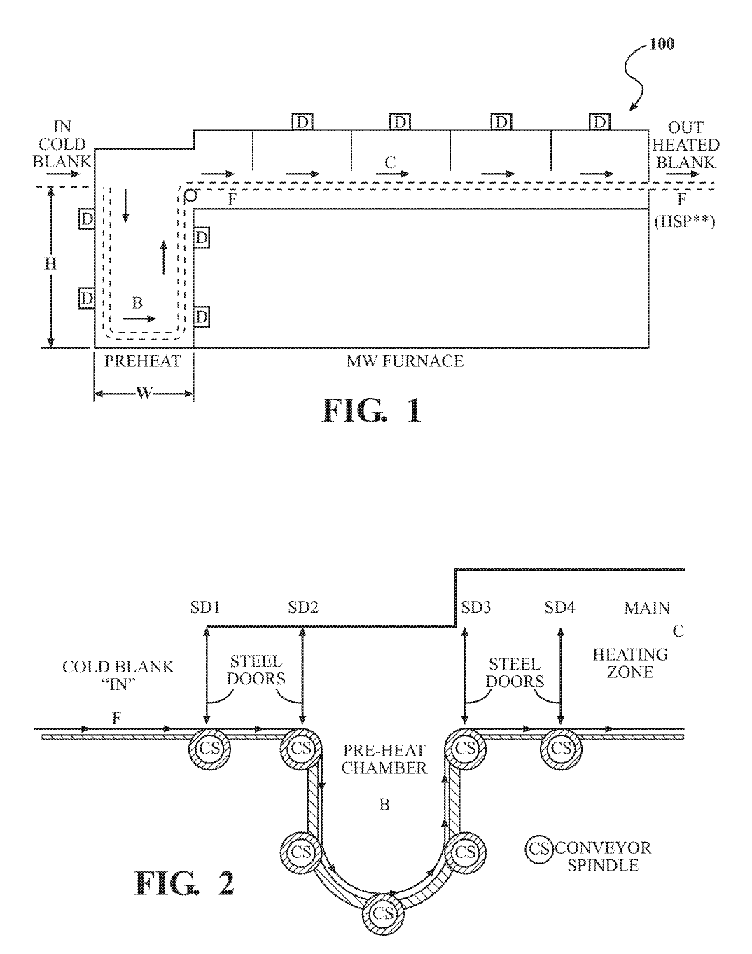

FIG. 1 shows a microwave furnace system 100 according to an embodiment of the present invention. The microwave furnace system 100 may include a pre-heat chamber B that heats a boron steel blank from room temperature (RT) to approximately 400° C.

The microwave furnace system includes a main heating zone C and an area G underneath the main heating zone C for the magnetrons, fans and other necessary components of a microwave furnace. The main heating zone C comprises multiple sub-zones built into the microwave furnace. In FIG. 1, the heating zone C comprises five sub-zones. Each sub-zone is configured to have a gradual increase in temperature as the steel blank passes through the main heating zone C and reaches the desired top temperature. One or more waveguides D is built in above the main heating zone C in each sub-zone. The main heating zone C heats the steel blank from approximately 400° C. to between 800° C. and 1000° C. in a processing time ranging from approximately 120 to 240 seconds depending on the shape and size of the boron steel blank. The height or depth H of the pre-heat chamber B may be greater than the width of the pre-heat chamber to decrease the footprint of the entire system.

The steel blanks heated may be made from boron steel. The boron steel may be aluminized. The microwave furnace system 100 may also be used to heat magnesium boron steel or carbon steel and other thin metal sheets.

The microwave furnace system 100 includes an entrance IN where the steel blanks pass through into a pre-heat chamber B and an exit OUT where the steel blanks leave the microwave furnace system 100.

The system uses a conveyor system F that starts from the entrance IN, makes a U-shape along the sides and the bottom of the pre-heat chamber B, and up into the main heating zone C where it continues to run though the length of the main heating zone C and until the exit OUT of the microwave furnace system.

A robotic arm (not shown) places the boron steel blanks at the entrance to the pre-heat chamber B, then the boron steel blanks are moved onto a conveyor system F. The direction of the arrows denotes the moving direction of the steel blank on the conveyor system from the entrance IN through the pre-heat chamber B and through the main heating zone C. Upon exiting the microwave furnace system 100, the steel blanks will be picked up by a robotic arm (not shown) that transfers the red-hot blanks from the microwave furnace system 100 directly to the Hot-Stamping Process (HSP).

FIG. 2 shows the flow of the steel blank through the pre-heat chamber B. When a boron steel blank enters through the door SD1, the door SD2 is closed. Then when the door SD1 closes behind the first blank the door SD2 opens to allow the blank to pass along the conveyor system through the pre-heat chamber B. Once a boron steel blank has entered the pre-heat chamber B, the door SD2 closes and the door SD1 opens to allow another boron steel blank to enter. The operation repeats itself after each blank passes through.

Similarly, when the boron steel blank leaves the pre-heat chamber B, the door SD3 opens. Once the boron steel blank is on the other side of the door SD3, the door SD3 closes, and the door SD4 opens to allow the boron steel blank to continue through the main heating zone C and on through the exit OUT.

The height H and width W of the pre-heat chamber B is determined by the total surface area of the boron steel blanks to be heated. The pre-heat chamber B is designed to accommodate increases in the production rate of the Hot-Stamping Process HSP as it has the possibility of multiple pre-heat zones which can be inter-changed with the main heating zone depending on the production demand. In addition, having additional pre-heat zones ensures that any maintenance downtime is eliminated so that 24/7 production can continue uninterrupted by just replacing one pre-heat chamber for another. The multiple pre-heat chambers can be brought into play as, when and if required. A quality inspection process is also incorporated with the multiple station setup.

The pre-heat chamber B is made of stainless steel and is concave in shape to maximize the efficiency of the microwaves and provide uniformity of heating temperature.

The conveyor system F is made of steel wire-mesh which can resist temperatures up to 1200° C. As the boron steel blanks at room temperature approach the steel door SD1, silicon carbide hooks hold the blanks in place through all the heating zones, and out of the furnace to be picked up robotically and removed which are red-hot for the HSP.

The boron steel blanks which have a thickness between 1 mm and 1.8 mm are pre-cut by laser, to a particular shape and are fed into the microwave furnace system 100 by the conveyor system F. The conveyor system can be a steel wire-mesh conveyor or other suitable material that reflects microwaves.

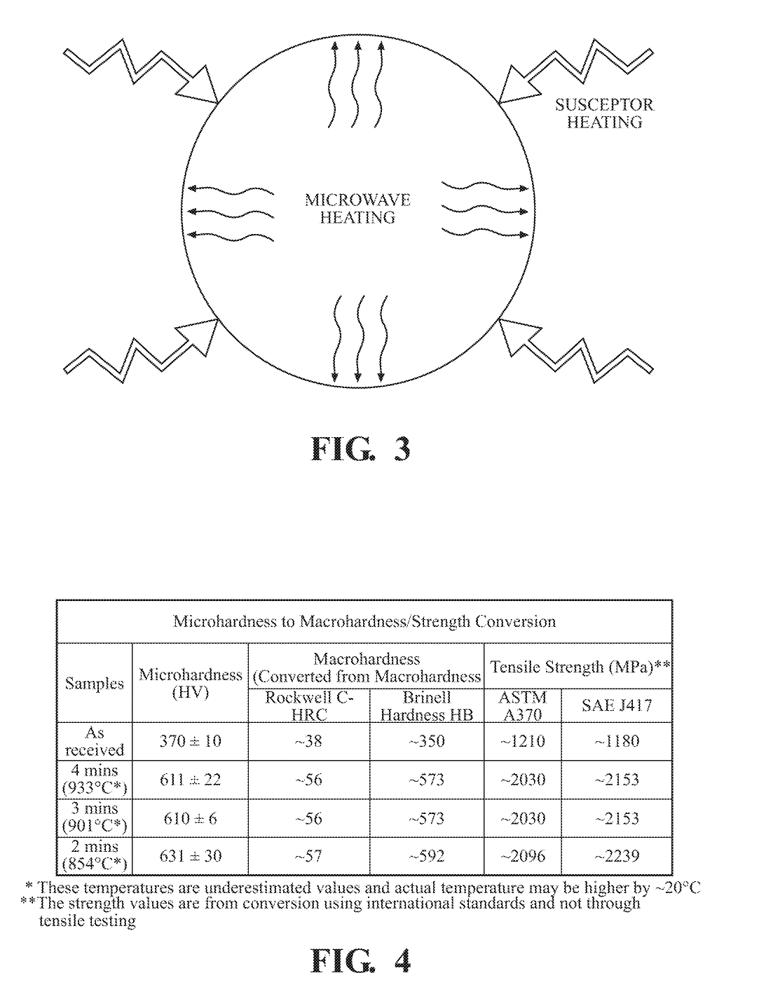

The microwave furnace system can be a 100% microwave heating system or a hybrid system that combines thermal heating via susceptors with microwave heating as shown in FIG. 3. In both types of the microwave furnace system, the microwave frequencies commonly used in industrial applications are 2450 MHz, and 915 MHz. Other frequencies may also be used.

The use of microwave in this application has many advantages compared to a conventional furnace. With a conventional furnace the energy is absorbed on the surface of the metal and only when sufficient heat has been created can the heat penetrate the whole metal blank by energy transfer. This process is time-consuming. But with a microwave furnace, the microwaves are absorbed by the whole metal blank as volumetric heating that is converted to energy resulting in rapid heating creating a uniform microwave field. A Microwave furnace is heating the steel blank directly by energy conversion. Microwave heating is therefore highly energy efficient thus reducing all harmful emissions.

Since microwaves can couple directly with a material causing it to heat up, the temperature in the material can be precisely controlled by regulating the supplied power. Heating takes place instantaneously when microwave energy is supplied and stops as soon as it is switched off, allowing for fast, efficient and accurate control.

Rapid heating also shortens the length of the furnace system by up to 70% and reduces the energy costs by up to 50%. The product throughput rate can be increased with inter-changeable pre-heat chambers depending upon the demand of the Hot-Stamping Process. For example, the microwave furnace system of the present invention may have a footprint length of only 5-8 meters.

FIG. 3 illustrates the efficiency of balancing thermal energy through susceptor heating (outside to inside) with microwave heating (inside to outside). The use of microwave heating also allows precise heating rate. The microwave heating method eliminates the risk of warping and reduces the risk of oxidation. The boron steel blanks retain their dimensional precision with increased microhardness and tensile strength, as shown in FIG. 4.

In a 100% microwave heating system, the blanks are heated directly by microwave energy generated in the microwave heating chamber. The term “directly” is defined herein as heating the metal blanks directly with microwave energy without any intermediate medium absorbing the microwave. In other words, the microwave interacts with the metal blanks directly.

In some embodiments, the ambient of the main heating chamber may be pre-heated using susceptors to a pre-determined temperature to minimize the heat loss from the blanks being heated.

Hybrid microwave heating involves the use of two types of energy: microwave energy and thermal energy, as illustrated in FIG. 3. In the present method, the thermal energy comes from the use of microwave susceptors, which are heated rapidly by microwaves, thus providing radiant heat to the blanks.

In a hybrid system, susceptor materials with excellent microwave absorption and heat-conducting properties such as silicon carbide (SiC) may be used throughout the system. In this case, the steel blanks are heated partly by direct microwave energy and partly by the thermal energy radiated from the susceptor materials. In the pre-heat chamber, the blank may be pre-heated by either microwave energy or by conventional or thermal heating. Pre-heating promotes a more uniform temperature.

The microwave furnace systems according to the embodiments of the present invention are closed systems with minimal heat loss. The main heating zone C might have a rectangular or cylindrical shape.

Example Experiment

Boron steel is used which may contain carbon of about 0.25-0.37 wt % C, 1.4% max manganese (Mn) and 0.5% max boron (B) as elements for improving heat treatment performance. The austenitizing temperature of boron steel is between 880-930° C. 900° C. is preferred. The microwave setup was heated to 920° C. for 43 minutes. The sample was put into the setup at 920° C. The setup with the sample inside was heated for 2-4 minutes. After microwave heating, the sample was taken out and water quenching was performed cooling >30° C.

As this is a continuous system each blank, or a combination of blanks of the same shape pass through the pre-heating furnace which can reach up to 854° C. in 2 minutes; up to 901° C. in 3 minutes, and 1,000° C. in 4 minutes.

Microwave heating can be one step heating where the sheets can be inserted into microwave furnace at room temperature. Samples did not show any warping. Microwave treatment can cut down the processing time from 240 s to 120-180 s time range, a maximum reduction by 50%. This is achieved at a lab scale and can be translated to industrial scale with this invention. As shown in the table of FIG. 4, tensile strength test ASTM A370 and tensile strength test SAE J417 were used. The strength of the samples can almost be doubled after the heating as indicated from the microhardness conversion in accordance with international standards. The microstructure of the samples can be martensitic after water quenching.

A microwave heating or hybrid heating system improves the material properties as the material is heated from the inside out by microwave energy, as shown in FIG. 4.

It will be clear to those of skill in the art, the embodiments of the present invention illustrated and discussed herein may be altered in various ways without departing from the scope or teaching of the present invention. Also, elements and aspects of one embodiment may be combined with elements and aspects of another embodiment. It is the following claims, including all equivalents, which define the scope of the invention.

1. A method of heating a metal blank using a microwave heating furnace system for a hot stamping process, the method comprising the steps of:
providing a metal blank having a thickness ranging from 1 mm to 1.8 mm;
pre-heating the metal blank to an initial temperature in a pre-heat chamber of the microwave heating furnace system; and
directly heating the metal blank using microwave energy in a main heating chamber of the microwave heating furnace system from the initial temperature to a temperature greater than 850° C. in less than 240 seconds.

2. The method according to claim 1, wherein the main heating zone includes two or more heating sub-zones, each sub-zone configured to increase a temperature range.

3. The method according to claim 1, wherein the steel blank is a boron steel blank.

4. The method according to claim 1, wherein the initial temperature is between 350° C. and 400° C.

5. The method according to claim 1, wherein the pre-heat chamber has a height greater than its width.

6. The method according to claim 1, wherein the pre-heating is done by microwave energy.

7. The method according to claim 1, wherein the pre-heating is done by thermal heating.

8. The method according to claim 3, wherein the boron steel blank is being heated using 100% microwave heating.

9. The method according to claim 3, wherein the heating energy for heating the boron steel blank is partially microwave energy.

10. The method according to claim 1, wherein the microwave heating furnace system further comprises a conveyor system for transporting the steel blank and silicon carbide nanocoated pins used to hold the steel blank in place on the conveyor system.

11. The method according to claim 1, wherein the microwave heating furnace system further comprises a conveyor system for transporting the metal blank and silicon carbide nanocoated hooks or clips used to hold the metal blank in place on the conveyor system.

12. The microwave heating furnace system according to claim 1, wherein the pre-heat and the main heating zone each comprise a steel mesh curtain or door to shield the microwave both into and out of the pre-heat chamber.

13. A microwave heating furnace system for heating metal blanks for hot stamping, comprising:
an incoming feed for feeding a metal blank into the furnace system;
a pre-heat chamber for heating the metal blank to an initial temperature;
a main heating zone adjacent to the pre-heat chamber having at least one heating sub-zone, the main heating zone configured to heat the metal blank from the pre-heat chamber to a second temperature in a processing time between 180 and 240 seconds;
an outgoing section for transferring the metal blank to a subsequent hot stamping process; and
a continuous conveyor system from the incoming feed through the pre-heat chamber and the main heating zone to the outgoing section for transferring the metal blank to the hot-stamping process.

14. The microwave heating furnace system according to claim 13, wherein the metal blank is a boron steel blank.

15. The microwave heating furnace system according to claim 14, wherein the boron steel blank has a thickness ranging from 1 mm to 1.8 mm.

16. The microwave heating furnace system according to claim 13, wherein the initial temperature is between 350° C. and 400° C.

17. The microwave heating furnace system according to claim 13, wherein the second temperature is greater than 850° C.

18. The microwave heating furnace system according to claim 13, wherein the main heating zone includes two or more heating sub-zones, the heating sub-zones configured to heat the metal blank from the pre-heating chamber to graded temperatures.
